(19) United States
(12) Patent Application Publication
(10) Pub. No.: US 2003/0048252 A1
(43) Pub. Date: Mar. 13, 2003

(54) Six degrees of freedom information indicator and six degrees of freedom information indicating method

(76) Inventors: Yashuyuki Fukushima, Ibaraki-ken (JP); Masaki Niwa, Chiba-ken (JP)

Correspondence Address: Joseph W. Berenato, III, Liniak, Berenato, Longacre & White, LLC, 6550 Rock Spring Drive, Ste. 240, Bethesda, MD, 20817, US

(21) Appl. No.: 10/214,459

(22) Filed: Aug. 8, 2002

(30) Foreign Application Priority Data
Aug. 10, 2001 (JP) 2001-244134
Jul. 19, 2002 (JP) JP2002-211484

(51) Int. Cl. G09G 5/00

(52) U.S. Cl. 345/156

(57) ABSTRACT

The present invention relates to a six degrees of freedom information indicator, used in combination with a position detector using electromagnetic induction, corresponding to displacement and rotation of an object on a 3D space displayed on a computer display. A first operational input means enters two degrees of freedom information using an operating member positioned on an upper surface of an enclosure; a second operational input means enters one degree of freedom information by operation of a sliding switch positioned on a side surface of the enclosure; a third operational input means enters absolute rotation angle information around the Z-axis by operation of a rotary operating member positioned on a side surface of the enclosure; and a bottom surface input means including a coordinate detecting coil enters X and Y coordinate values by operation of the indicator within a plane parallel to the position detector surface.

### CROSS-REFERENCE TO RELATED APPLICATION AND CLAIM TO PRIORITY

Applicant hereby claims priority to Japanese Application No. 2001-244134, filed Aug. 10, 2001, titled “Six Degrees of Freedom Information Indicator and Six Degrees of Freedom Information Indicating Method”, whereby said application was filed in Japan for the same invention. A declaration of domestic priority was filed Jul. 19, 2002 in Japanese Application No. 2002-211484.

### BACKGROUND OF THE INVENTION

1. Field of the invention

The present invention relates to an indicator for entering information into a computer for six degrees of freedom of an object displayed on a computer display. The six degrees of freedom information indicator is used in combination with a position detector using electromagnetic induction. The invention enables an operator to easily input data using input means which achieve movement of an input operating section corresponding to a desired movement of an object from six degrees of freedom information (X, Y, Pitch, Roll and Yaw). Thus, the operator may control movement and rotation of an object in a three dimensional (“3D”) space.

2. Description of Related Art

Six degrees of freedom include coordinate movements along the X, Y, and Z axis, as well as rotation on those axes. Rotation around the Z axis is known as roll. Around the Y-axis rotation is called yaw. X-axis rotation is known as pitch.

An input device, known as the SpaceBall™, permits simultaneous input of six degrees of freedom information of an object in a 3D space. For example, the SpaceBall™ 4000 FLX has a fixed ball-type sensor that senses the magnitude of a force when an operator touches the ball-type sensor. Information is then entered which controls a 3D object. Thus, the SpaceBall™ is a single input means having a pressure-sensitive sensor.

Problems arise because the six degrees of freedom information are not independently controlled with the SpaceBall™. As such, information regarding one or more of the degrees of freedom is often entered unintentionally, and therefore improperly. Furthermore, it is difficult to enter absolute coordinates or an absolute angle, given information is not entered by moving or rotating the input section (i.e. operational intuition is hampered). Finally, the SpaceBall™ does not have a graphical user interface (“GUI”) navigation function using movement on only the X and Y-axis, as on a mouse, and is therefore used primarily for 3D applications only.

Another input device known in the art provides for a position detector and position indicator. The position detector, such as a tablet, may have loop coils positioned parallel to the position detecting direction. The position indicator may have a resonance circuit, as disclosed in Japanese Unexamined Patent Application Publication No. 63-70326. Generally, an AC signal of a prescribed frequency is applied to a loop coil, which causes it to transmit radio waves (including an AC electric field, an AC magnetic field, or an AC electromagnetic field). A resonance circuit in the position indicator receives the transmitted radio waves. After receiving the radio waves, the resonance circuit transmits radio waves to the loop coil. This operation is repeated by sequentially ‘switching on’ a plurality of the loop coils in the position detector. Coordinate values for the position indicated by the position indicator are detected by determining the level of an induced voltage generated in each of the loop coils.

Accordingly, coordinate values for the position indicated by the position indicator are determined by transmitting/receiving radio waves between the position detector and the position indicator. Thus, absolute coordinate values (i.e. X and Y coordinate values on the surface of the position detector) are determined. However, information for six or more degrees of freedom necessary for controlling the movement and rotation of an object in 3D space is not determined using the conventional position detector and position indicator.

An improved position detector and position indicator that detects the rotation angle of the position indicator has previously been proposed in Japanese Unexamined Patent Application Publication No. 8-30374. Specifically, a position indicator is provided having a resonance circuit with a first coil for detecting coordinates and a second control coil in parallel with the first coil that surrounds part of a magnetic flux generated by the first coil. The control coil causes a change in the distribution of the magnetic flux passing through the first coil, thereby permitting detection of a rotation angle. However, even this improved input device is only able to simultaneously enter information for three degrees of freedom (X, Y and Z, wherein Z is the rotation angle around the Z-axis).

Therefore, conventional input devices do not adequately permit the simultaneous input of six-degrees of freedom information.

### SUMMARY OF THE INVENTION

The present invention provides a six degrees of freedom information indicator used in combination with a position detector, which uses electromagnetic induction. The disclosed invention enables an operator to enter information for six degrees of freedom into a computer with one hand, which controls the movement and rotation of an object displayed in 3D space on a computer display.

The disclosed information indicator comprises an enclosure having a bottom surface and a plurality of operational input means. The input means are contacted by an operator's fingers on the enclosure of the six-degree of freedom information indicator, and operable by the operator's fingers independently of each other. A bottom surface of the input means comprises a coordinate detecting coil provided on the bottom surface of the enclosure of the six degrees of freedom information indicator. Transmitting means transmit one or more degrees of freedom information signals, corresponding to the operation of at least one input means from among the plurality of operational input means. The signals are transmitted using the electromagnetic inducing action of the position detector. The operator provides information for the X and Y directions by moving the enclosure of the information indicator on the bottom surface of the indicator within a plane parallel to the position detector surface. The remaining four degrees of freedom information are entered using the plurality of operational input means.

Therefore, the user may enter four degrees of freedom information (PITCH, ROLL, YAW and Z) with one hand, using the plurality of operational input means. The two degrees of freedom information, X and Y coordinate values, are determined by bottom surface input means including a two-coordinate detecting coil. Thus, six degrees of freedom information are determined.

In addition to determining six degrees of freedom information, the bottom surface input means may be utilized for general GUI navigating operations. The information indicator may be used on the tablet surface of the position detector using electromagnetic induction.

In a preferred embodiment of the invention, the transmitting means comprises: receiving means for receiving an AC electric field, an AC magnetic field or an AC electromagnetic field of a certain frequency transmitted from the position detector; returning means for returning an AC electric field, an AC magnetic field or an AC electromagnetic field of an arbitrary frequency to the position detector; converting means for converting one or more pieces of degree of freedom information into time lengths; counting means for performing binarization by counting the number of waves of the AC electric field, the AC magnetic field or the AC electromagnetic field of the frequency received during one or more conversions by the converting means; and control means for controlling the receiving means in response to binary code, which represents a plurality of pieces of degree of freedom information determined by the counting means. The control means also causes a change in the AC electric field, the AC magnetic field or the AC electromagnetic field to be returned to the position detector.

The receiving means and the returning means may be a resonance circuit comprising a coordinate detecting coil. At least one of the plurality of operational input means may have a time constant circuit, and may acquire information from continuous operation as continuous analog information. At least one of the plurality of operational input means may have a switch detecting circuit, and may acquire the discrete amount of operation of the operator as discrete digital information.

In addition, one of the plurality of operational input means may comprise a rotary member, which performs rotating movement around the center of the coordinate detecting coil. An operating member causes the rotary member to rotate by operation of the user. A rotation angle detecting coil is also provided, having a center deviating toward the inside of the coordinate detecting coil so that the position varies along with rotation of the rotary member. The radius of the rotation angle detecting coil is smaller than that of the coordinate detecting coil. A control circuit controls at least the rotation angle detecting coil, and causes a change in the distribution of magnetic fluxes passing through the coordinate detecting coil. The absolute rotation angle information around the Z-axis is determined by use of the electromagnetic induction by the operator's rotation of the operating member.

The operational input means may have an inertial wheel. The movement information for the Z-axis direction may be entered through inertial rotation of the inertial wheel.

The operational input means may be a stick controller or a sliding switch, which automatically returns to an initial positional value when the user releases the operational input means.

The operational input means may be absolute information input means, which maintains the information upon completion of operation when the user releases the operational input means.

### BRIEF DESCRIPTION OF THE DRAWINGS

FIG. 1 shows the six degrees of freedom information indicator according to a first embodiment of the disclosed invention;

FIG. 2 is a schematic circuit diagram of portions of a position detector used in combination with the six degrees of freedom information indicator;

FIG. 3 is a perspective view illustrating a first operational input means in the six degrees of freedom information indicator;

FIG. 4 is a perspective view illustrating a second operational input means in the six degrees of freedom information indicator;

FIG. 5 is a schematic circuit diagram of portions of a transmitting circuit;

FIG. 6 is a schematic circuit diagram of a converting means (time constant circuit);

FIG. 7 is a perspective view illustrating a third operational input means and bottom surface input means in the six degrees of freedom information indicator;

FIG. 8 is a schematic circuit diagram of portions of a control circuit;

FIG. 9 is a flowchart of a control program for detecting the XY coordinates and the rotation angle around the Z-axis;

FIG. 10 is an exterior view of the six degrees of freedom information indicator of a second embodiment of the disclosed invention;

FIG. 11 is an exterior view of the six degrees of freedom information indicator of a third embodiment of the disclosed invention;

FIG. 12 is an exterior view of the six degrees of freedom information indicator of a fourth embodiment of the disclosed invention; and

FIG. 13 is an exterior view of the six-degree of freedom information indicator of a fifth embodiment of the disclosed invention.

### DETAILED DESCRIPTION OF THE INVENTION

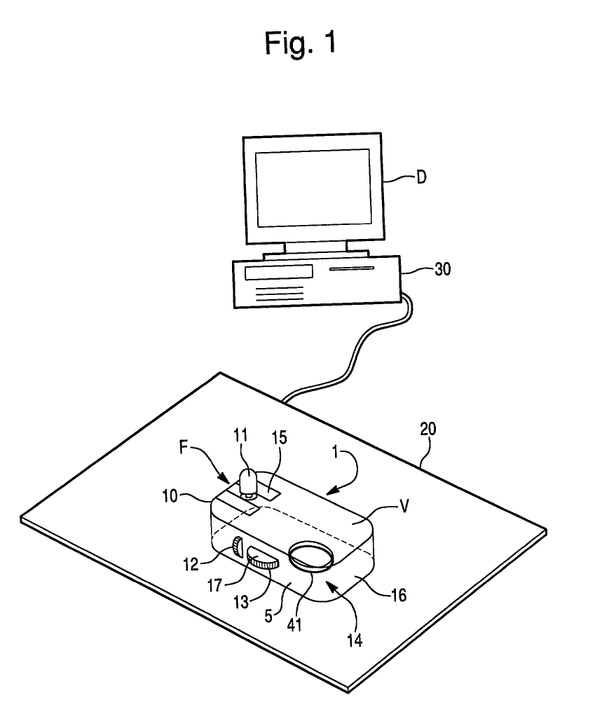

A first embodiment of the disclosed invention is best shown in FIG. 1. The six degrees of freedom information indicator 1 has a puck-shaped enclosure 10. A first input means 11 is provided at the front F of the upper surface U of enclosure 10. A second operational input means 12 and a third operational input means 13 are provided on a side S of enclosure 10. A bottom surface input means 14, having a coordinate detecting coil 41, is provided on the bottom surface 16 of enclosure 10. In addition, two operating switches 15 are provided, similar to those provided on a conventional mouse, and may be used to operate various functions in GUI navigation applications.

Indicator 1 is used in combination with a position detector 20 that uses electromagnetic induction, and serves as an input unit for a computer 30, which is operably associated with position detector 20. A display D is operably associated with computer 30. Position detector 20 may be a tablet or a digitizer, and includes a flat position detecting area, as known in the art. Generally, position detector 20 detects the position of indicator 1 using electromagnetic induction (electromagnetic coupling), and determines the X-axis and Y-axis coordinates of indicator 1. Indicator 1 includes a capacitor, which is connected to the coordinate detecting coil 41 (explained in detail below), and forms a resonance circuit.

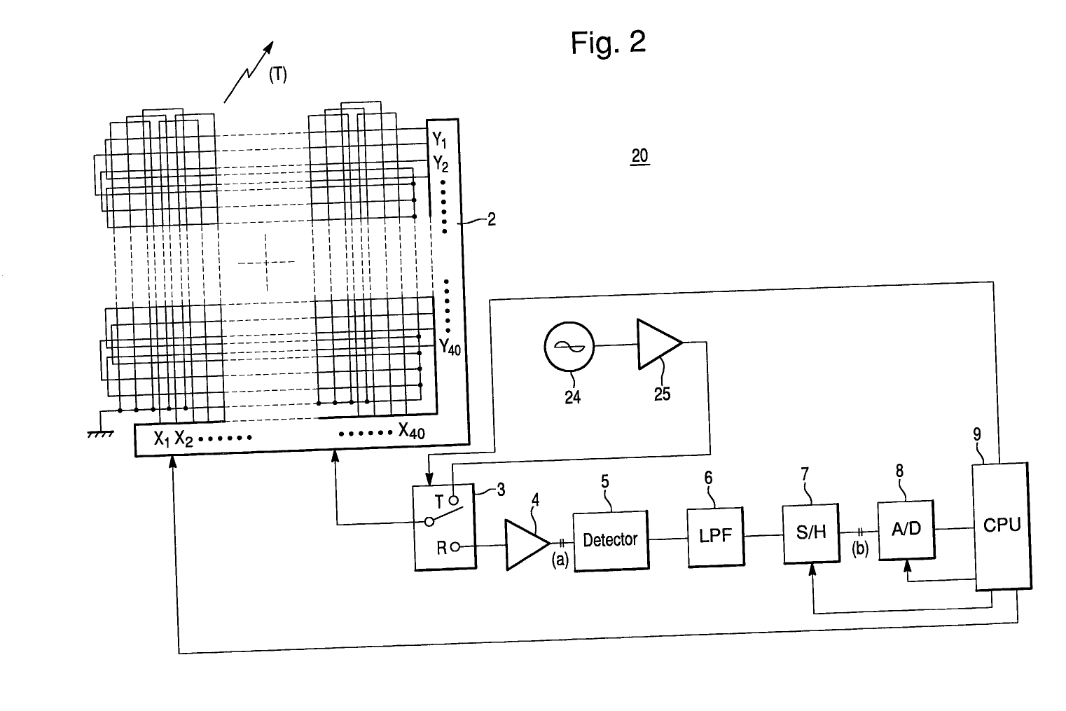

FIG. 2 is a schematic diagram of portions of the circuit configuration of position detector 20. Forty (40) loop coils X₁-X₄₀ are arranged in the X-direction in parallel. Likewise, forty (40) loop coils Y₁-Y₄₀ are arranged in the Y-direction in parallel. These loop coils are connected to a selection circuit 2, which selects any one of the individual loop coils. Selection circuit 2 is connected to a transmission/receiving switching circuit 3, which in turn is connected to an amplifier 4. Amplifier 4 is connected to a detecting circuit 5. Detecting circuit 5 is connected to a low-pass filter 6. Low-pass filter 6 is connected to a sample-and-hold circuit 7. Sample-and-hold circuit 7 is connected to an A/D circuit 8 (analog/digital converting circuit). A/D circuit 8 is connected to a central processing unit 9 (CPU). A control signal is entered from CPU 9 into selection circuit 2, sample-and-hold circuit 7, A/D circuit 8, and transmission/receiving switching circuit 3. A generator 24 generates a sine wave AC signal with a frequency equal to the resonance frequency of the resonance circuit of indicator 1. A current driver 25 converts the AC signal into a current.

As best shown in FIG. 1, indicator 1 and position detector 20 are not connected by cables. Rather, indicator 1 and detector 20 transmit signals using electromagnetic induction (electromagnetic coupling) between coordinate detecting coil 41 and the loop coils of position detector 20. Thus, indicator 1 and position detector 20 provide a wireless input environment.

As known in the art, position detector 20 is operably associated with computer 30, appropriately connected by an interface cable. An RS-232C interface or a USB interface may be used as an interface.

Coordinate detecting coil 41 serves as a receiving means for sending a degree-of-freedom information signal to position detector 20 in response to a user's operation of first operational input means 11 and second operational input means 12. Coordinate detecting coil 41 also serves as a returning means, and as part of the resonance circuit for detecting the X, Y coordinates and a rotation angle around the Z-axis. Coordinate detecting coil 41, located on the bottom surface 16 in the interior of enclosure 10, is not externally visible. (FIG. 1 shows a transparent enclosure 10 for purposes of explanation herein).

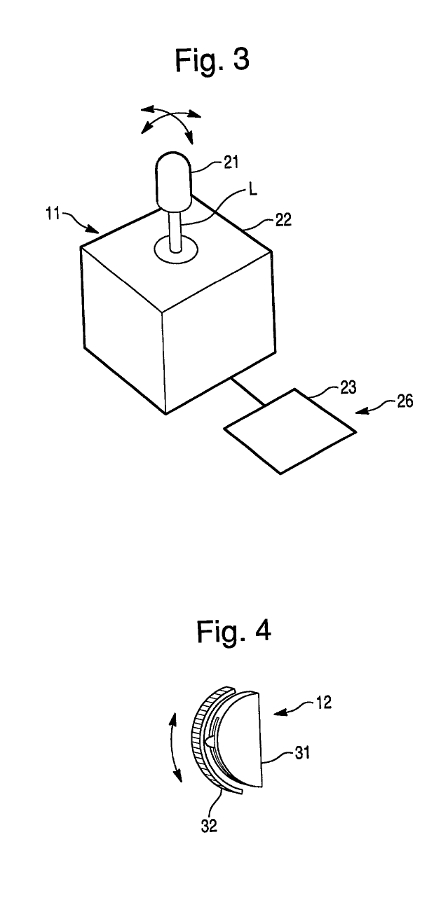

A perspective view showing first operational input means 11 is best shown in FIG. 3. An operating member 21 is attached to a lever L of a stick controller 22. The user contacts operating member 21, which is the only visible portion on indicator 1, as shown in FIG. 1. Stick controller 22 may be a self-median returning resistance variable type, such as the RKJXK1224VR manufactured by Alps Electric Co., Ltd. Operating member 21 can be tilted about 30° in any direction relative the initial position that is perpendicular to the top surface of stick controller 22. After operation, operating member 21 automatically returns to the initial position. Stick controller 22 has two rotary variable resistance elements disposed at right angles to each other. The resistance value of these two variable resistance elements depends on the inclination direction and the inclination angle of operating member 21. Each of the variable resistance elements of stick controller 22 is connected to a transmitting circuit 26, explained below, with a time constant circuit 23 as the converting means.

A perspective view of second operational input means 12 is best shown in FIG. 4. Second operational input means 12 includes a lever-operated sliding switch 31, and a lever 32 thereon. Sliding lever 32 generates two position signals, which are determined based on the angle of lever 32. Sliding switch SLLB-A-B, made by Alps Electric Co., Ltd., may be used. Only the lever 32 of second operation input means 12 is visible to the user, as shown in FIG. 1. Sliding switch 31 outputs four different signals, which are determined by the sliding direction and the sliding angle of lever 32. The resulting switch signal is output to transmission circuit 26.

Transmitting circuit 26 transmits the output signals received from first operational input means 11 and second operational input means 12 as degree-of-freedom information by use of electromagnetic induction. The information is transmitted from indicator 10 to position detector 20.

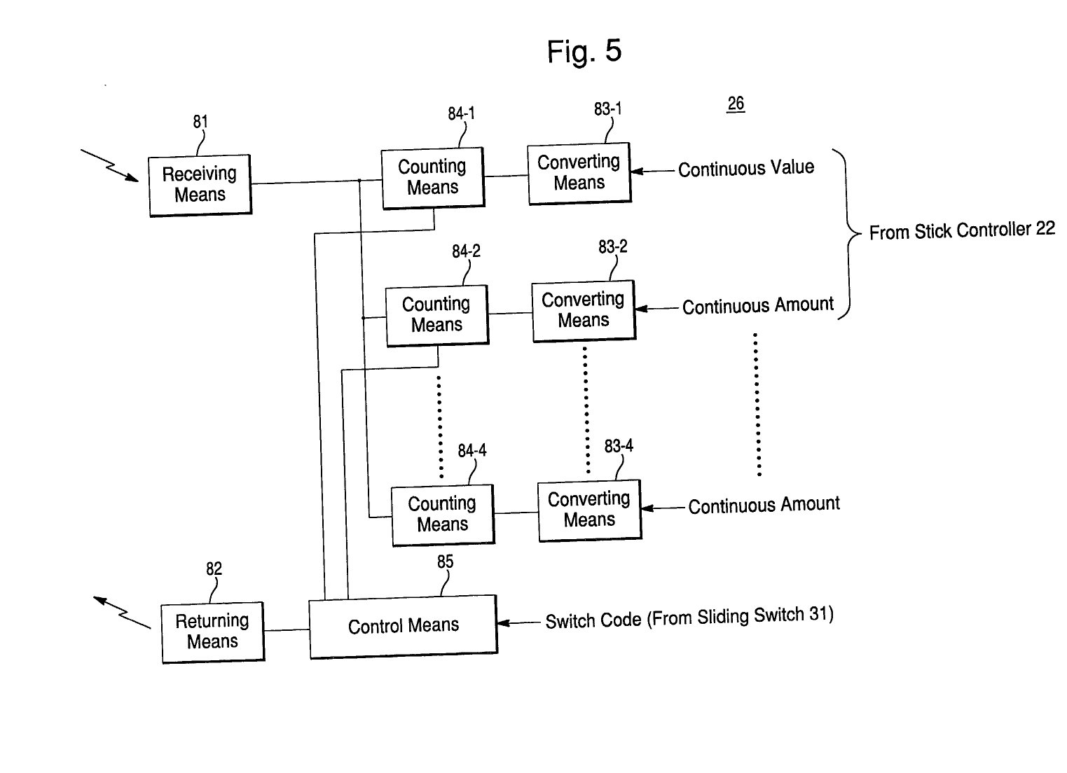

FIG. 5 is a schematic circuit diagram of portions of the circuit configuration of transmitting circuit 26. Receiving means 81 receives an AC electric field, an AC magnetic field, or an AC electromagnetic field of a certain frequency emitted from position detector 20. A returning means 82 returns the AC electric field, the AC magnetic field, or the AC electromagnetic field of an arbitrary frequency to position detector 20. Converting means, 83-1, 83-2 . . . 83-4, convert information corresponding to operations from continuous values to a plurality of time periods. Counting means, 84-1, 84-2 . . . 84-4, count and binarize the number of waves of the AC electric field, the AC magnetic field, or the AC electromagnetic field of a certain received frequency from the plurality of time periods converted by the converting means 83-1 . . . 83-4. Control means 85 controls returning means 82 in response to the plurality of binary codes determined by the converting means 84-1 to 84-4, thereby causing a change in the AC electric field, the AC magnetic field, or the AC electromagnetic field sent to position detector 20. Thus, the circuit configuration shown in FIG. 5 transmits four degrees of freedom information, which corresponds to four operations, each represented by a continuous value.

Output signals corresponding to operations for two degrees of freedom are discussed in detail hereafter, wherein stick controller 22 serves as first operational input means 11, and sliding switch 31 serves as second operational input means 12.

Receiving means 81 and returning means 82 may be a resonance circuit comprising a capacitor connected to coordinate detecting coil 41 on bottom surface input means 14.

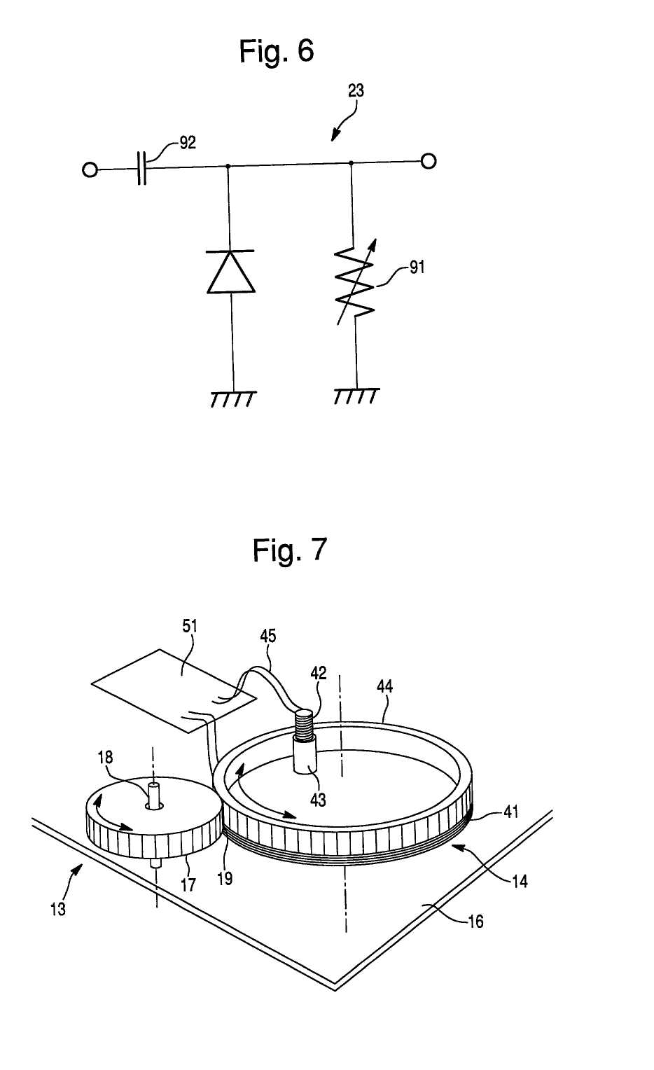

An example of converting means 83-1 and 83-2 are shown in detail in FIG. 6. A time constant circuit 23 comprises an individual variable resistance element 91 and a capacitor 92. The resistance of variable resistance element 91 varies depending on the operation of operating member 21 of stick controller 22. Specifically, the resistance varies with the inclination direction and inclination angle of operating member 21. The discharge characteristics of time constant circuit 23 vary depending on the resistance of variable resistance element 91. Therefore, it is possible to convert two degrees of freedom information (corresponding to operations) from continuous values into times when the discharge characteristics vary.

While signals are output from converting means 83-1 and 83-2, counting means 84-1 and 84-2 count the number of waves of the induction voltage. (Radio waves are generated in the resonance circuit from position detector 20). As such, it is possible to binarize two degrees of freedom information, which are expressed by continuous values, if stick controller 22 serves as first operational input means 11.

An output signal from sliding switch 31, serving as second operational input means 12, is output to control means 85. This output signal comprises four different switching signals, which vary according to the sliding direction and the sliding angle of lever 32. Control means 85 causes a change in the resonance characteristics of the resonance circuit forming returning means 82 in response to the binarized signals output from counting means 84-1 and 84-2 and the switching code signal.

Therefore, two degrees of freedom information, expressed by continuous values, are transmitted in response to operations of stick controller 22, and one degree of freedom information is transmitted in response to an operation of sliding switch 31, from indicator 1 to position detector 20.

A third operational input means 13 and bottom surface input means 14 are best shown in FIG. 7. Third operational input means 13 has a rotary operating member 17, a rotation angle detecting coil 42, and a rotary disk 44. Rotary operating member 17 is rotatable around a rotation axis 18 relative to bottom surface 16 of enclosure 10. Rotary operating member 17 is exposed on a side of enclosure 10, and may be rotated horizontally by one of the user's fingers.

Rotary disk 44 is rotatable relative to bottom surface 16 of enclosure 10, whereby the rotational center thereof is the center of coordinate detecting coil 41. Rotary disk 44 contacts rotary operating member 17 via a rotation movement transmitting means 19, such as a gear, as shown in FIG. 7. Rotation angle detecting coil 42 comprises a plurality of turns of a signal line wound around a rod-shaped ferrite core (magnetic core material). A coil holder 43 is positioned off-center of rotary disk 44, which is in turn freely rotatable around a center axis deviated from rotary disk 44. While rotation angle detecting coil 42 is fixed relative to coil holder 43, coil holder 43 is rotatable around the center axis. Rotation angle detecting coil 42 is therefore freely rotatable around the coil rotation axis.

Signal lines 45 from the ends of rotation angle detecting coil 42 extend from above the ferrite core toward a control circuit 51. Control circuit 51 comprises a printed board fixed on bottom surface 16 of enclosure 10. Signal lines 45 are relatively rigid. Even when the rotary disk rotates, and the position of rotation angle detecting coil 42 varies (i.e. causing the ferrite core of rotation angle detecting coil 42 to rotate around the center axis), the ends of signal lines 45 are always directed toward control circuit 51. The length of signal lines 45 ensure that the lines 45 will not break or lose rigidity, even when rotation angle detecting coil 42 is rotated the maximum amount from control circuit 51.

Coordinate detecting coil 41 serves as the bottom surface input means 14, and is a circular coil fixed to bottom surface 16 of enclosure 10. As shown in FIG. 7, coordinate detecting coil 41 may be an air-core coil (i.e. a coil not having a core). Coordinate detecting coil 41 is preferably wound in a plurality of turns, which achieves sufficient magnetic flux intensity and forms an effective resonance circuit. The circular shape of coordinate detecting coil 41 is rotationally symmetrical relative to the center of the circle. When an AC current flows through coordinate detecting coil 41, a magnetic flux is generated therefrom, which is also rotationally symmetrical.

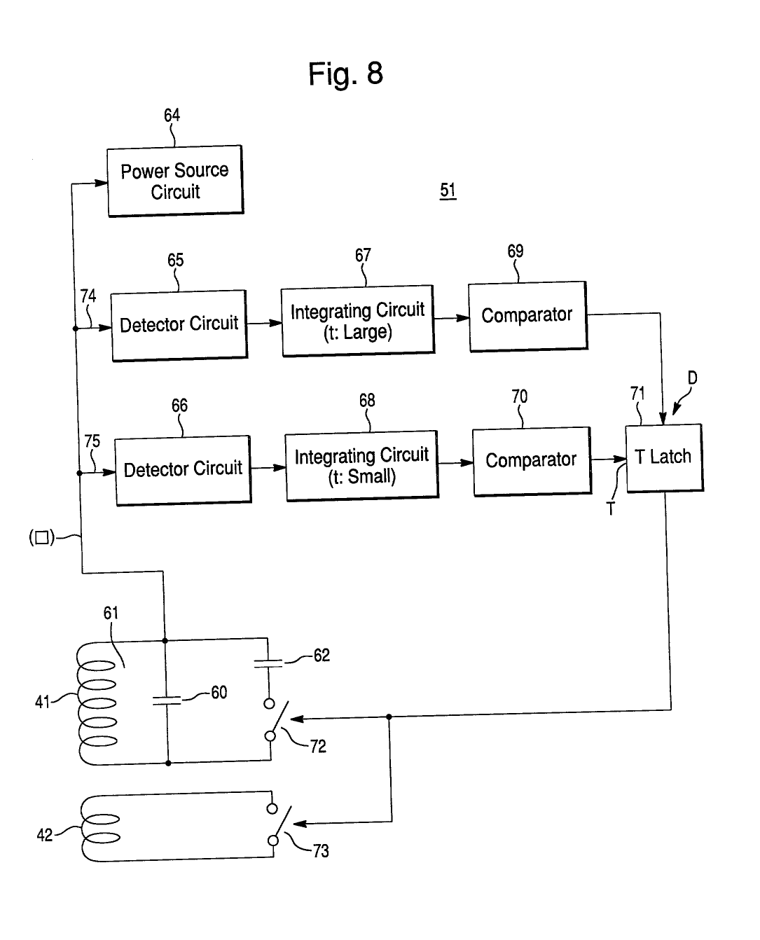

A schematic circuit diagram of portions of control circuit 51 is best shown in FIG. 8. A capacitor 60 is connected to coordinate detecting coil 41, forming a resonance circuit 61. A compensating capacitor 62 is connected to resonance circuit 61. The capacitance of compensating capacitor 62 is selected so that, upon switching the rotation angle detecting coil 42, the resonance frequency of resonance circuit 61 matches the frequency of the transmitted wave (transmitted signal) from position detector 20.

Resonance circuit 61 is connected to a power supply circuit 64, a detector circuit 65, and a second detector circuit 66. Detector circuit 65 is connected to an integrating circuit 67 having a first time constant. Second detector circuit 66 is connected to an integrating circuit 68 having a time constant less than the first time constant. Integrating circuit 67 is connected to a comparator 69, and the integrating circuit 68 is connected to a comparator 70. Comparator 69 is connected to a data terminal D of a latch circuit 71. Comparator 70 is connected to a trigger terminal T of latch circuit 71.

A switch 72 is connected in series to compensating capacitor 62, which is connected to resonance circuit 61. A switch 73 is connected to rotation angle detecting coil 42. The output of latch circuit 71 is connected to both switches 72 and 73.

Integrating circuit 67 and comparator 69 form a first path 74. The output from first path 74 is supplied to data terminal D of latch circuit 71. A signal representing the relationship between the time constant of integrating circuit 67 and the reference value of comparator 69 is output when the transmitting wave from position detector 20 is transmitted for a first prescribed period of time (for example, a period of time sufficiently longer than 300 μs).

Integrating circuit 68 and comparator 70 form a second path 75. The output from second path 75 is supplied to trigger terminal T of latch circuit 71. A signal representing the relationship between the time constant of integrating circuit 68 and the reference value of comparator 70 is output when the transmitting wave from position detector 20 is transmitted for a second prescribed period of time, which is shorter than the first prescribed period of time (for example, a period of time sufficiently longer than 100 μs).

Integrating circuit 67 and integrating circuit 68 are CR circuits, and may comprise, for example, a resistor and a capacitor in combination. The resistance and electrostatic capacitance of integrating circuit 67 are R1 and C1, respectively. The resistance and electrostatic capacitance of integrating circuit 68 are R2 and C2, respectively. The relationship between integrating circuit 67 and integrating circuit 68 is such that, C1R1>C2R2.

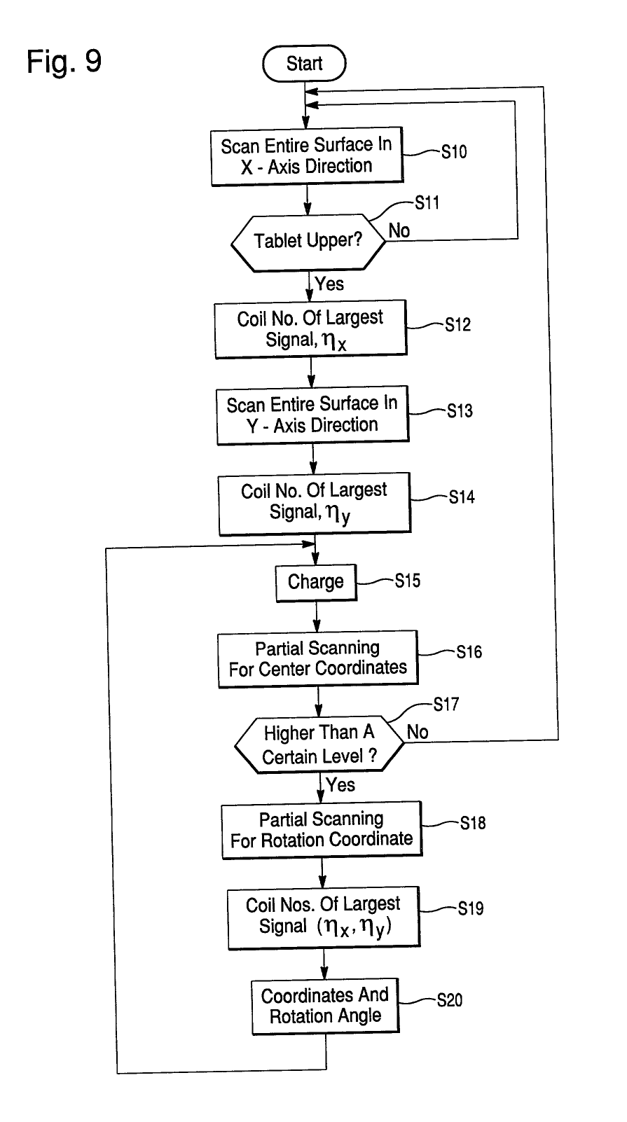

FIG. 9 is a flowchart of a control process for detecting the X, Y coordinates and the rotation angle around the Z-axis. This process is executed by CPU 9 in position detector 20.

First, position detector 20 is scanned to determine the X-axis position of indicator 1 at S10. Specifically, CPU 9 causes selection circuit 2 to select loop coil X₁, which connects transmission/receiving switching circuit 3 to transmitting side terminal T, and supplies a sine wave AC signal of transmitter 24 to loop coil X₁. As a result, a transmitted electromagnetic wave at the resonance frequency is transmitted from loop coil X₁ to resonance circuit 61 of indicator 1. Following a prescribed period of time (for example, T=100 μs), CPU 9 switches over transmission/receiving switching circuit 9 to the receiving side, and executes the receiving mode for receiving signals from indicator 1 for a prescribed period of time (for example, R=100 μs). This operation is individually carried out for all loop coils X₁ to X₄₀ in the X-axis direction. The selected loop coil has the largest received signal from indicator 1. In this way, the X-axis position of indicator 1 on position detector 20 is determined.

Switches 72 and 73 are open, allowing resonance circuit 61 to become excited by the transmitted electromagnetic wave, thus generating an induction voltage. In the receiving mode, the transmitted wave is discontinued. However, radio waves are generated from coordinate detecting coil 41 due to the effect of the induction voltage. This wave, in turn, excites the selected loop coil of position detector 20, thereby generating an induced voltage in the loop coil. This induced voltage is maximized in the loop coil closest to the center coordinates of coordinate detecting coil 41. The center coordinates, i.e., the X, Y coordinates, can therefore be determined from the input six degrees of freedom information.

CPU 9 repeats the transmission mode and the receiving mode for all the loop coils, and causes selection circuit 2 to select loop coils to turn sequentially. Thus, a radio wave is transmitted from the loop coil to indicator 1. Resonance circuit 61, including coordinate detecting coil 41, is excited by the transmitted wave, thus generating an induced voltage in resonance circuit 61. After execution of the transmission mode for a prescribed period of time, position detector 20 enters the receiving mode, and the transmitted wave stops.

Until the induced voltage is attenuated, radio waves are transmitted from coordinate detecting coil 41. These waves are received by the selected loop coil, which is then excited, thus generating an induced voltage in the loop coil. This induced voltage is amplified by an amplifier 4. The amplified signal is detected in detector circuit 5, and output to low-pass filter 6. Low-pass filter 6 has a cut-off frequency sufficiently lower than the resonance frequency of resonance circuit 61, and converts the output signal of detector circuit 5 into a DC signal. The DC signal is sampled and held in sample holding circuit 7, and thereafter is converted from analog to digital in A/D circuit 8. The digital value is then output to CPU 9. CPU 9 detects the position of indicator 1 in the X-axis direction based on the distribution of the received signals converted into digital values. CPU 9 stores the number of the loop coil where the received signal level becomes the highest as an X-direction position for indicator 1 at S12.

During X-axis scanning, if the received signal levels in position detector 20 are lower than a prescribed threshold value, CPU 9 determines that indicator 1 is not on position detector 20, and thereafter repeats the X-axis scanning at S11.

Likewise, the same scanning process determines the Y-axis position of indicator 1 on position detector 20 at S10. CPU 9 stores the loop coil having the highest received signal level as a position in the Y-axis direction on position detector 20 by the same operation as described above at S13 and S14.

When a particular coil number on position detector 20, specified by indicator 1, is determined, the particular coil and five loop coils before and after the particular coil are scanned at S16. This partial scanning ensures increased accuracy for detecting the position of indicator 1, and detection of the locus of indicator 1 if same is moved on position detector 20.

A charging operation is started at S15. CPU 9 causes selection circuit 2 to select a loop coil stored at S12, and connects transmission/receiving switching circuit 3 to transmitting-side terminal T. In this state, CPU 9 transmits the transmitted radio wave from this loop coil to indicator 1 for a prescribed period of time (for example, T=300 μs). As a result, an induced voltage is generated in resonance circuit 61, and power source circuit 64 is charged by this induced voltage. The induced voltage is input to both detector circuits, 65 and 66, and a detector output is issued from each of detector circuits 65 and 66.

This detector output causes an output of integrating circuit 68 from second path 75, and a comparator output. However, because CPU 9 transmits the same for a transmitting period of 300 μs, comparator 69 does not output from first path 74.

For charging, CPU 9 transfers to partial scanning after a prescribed receiving time (for example, R=100 μs) after the transmitting time T=300 μs at S16.

CPU 9 causes selection circuit 2 to select the loop coil in the X-axis direction stored at S12, and connects transmission/receiving switching circuit 3 to the transmitting-side terminal T. In this state, the loop coil sends the transmitted radio waves to indicator 1. Resonance circuit 61, including coordinate detecting coil 41, is excited by the transmitted radio waves, and an induced voltage is thereby generated in resonance circuit 61. This induced voltage is detected in detector circuits 65 and 66, and detector outputs are issued. One detector output is integrated in integrating circuit 68, and the integrated output is compared to a reference value in comparator 70. Similarly, the other detector output is integrated in integrating circuit 67, and the integrated output is compared to a reference value in comparator 69.

Because the transmission mode period by CPU 9 is T=100 μs, no output is provided from first path 74 or second path 75. No output is provided by latch circuit 71, and switches 72 and 73 are left open. When switches 72 and 73 are left open, a uniform AC magnetic field is generated from the coordinate detecting coil 41 due to the induced voltage produced in resonance circuit 61. As a result, a center coordinate of coordinate detecting coil 41 on position detector 20 is detected.

After the transmission mode period, CPU 9 causes selection circuit 2 to select the loop coil stored at S12, and switches over transmission/receiving switching circuit 3 to the receiving-side terminal R. In this receiving mode of the loop coil, a receiving signal is obtained in position detector 20 by the same operations as described above at S10. This partial scanning operation selects the loop coil stored at S12 in the transmission mode, and selects four preceding and following loop coils in the receiving mode, and operations are sequentially carried out.

After this partial scanning in the X-axis direction, partial scanning in the Y-axis direction is similarly carried out for five loop coils before, after and including the loop coil stored at S14.

In the partial scanning operation, if the received signal level is lower than a prescribed threshold value, CPU 9 determines that indicator 1 is not on position detector 20 at S17, and the process returns to S10.

When partial scanning operations for determining X and Y positions are complete, CPU 9 conducts partial scanning to determine the rotation angle by activating rotation angle detecting coil 42 at S18.

In order to switch on rotation angle detecting coil 42, CPU 9 causes position detector 20 to transmit radio waves for a prescribed period of time. That is, CPU 9 causes selection circuit 2 to select the loop coil stored at S12, and connects transmission/receiving switching circuit 3 to the transmitting-side terminal T. In this state, CPU 9 transmits radio waves from this loop coil to indicator 1. As a result, an inducted voltage is generated in resonance circuit 61. The generated induced voltage is input to both detector circuits 65 and 66, and detector circuits 65 and 66 each provide a detector output.

Second path 75 is configured such that, when the transmitted electromagnetic waves are output for a period of time sufficiently longer than 100 μs (for example, for 200 μs), the output of comparator 70 is sent to latch circuit 71. Since the transmission period of position detector 20 is 700 μs, the output of comparator 70 is provided during this transmission period.

On the other hand, when the transmitted electromagnetic waves are output for a period of time sufficiently longer than 300 μs (for example, for 400 μs), first path 74 is configured so that the comparator output is issued to latch circuit 71. Since the transmission period of position detector 20 is 700 μs, the comparator output is provided during this transmission period.

Latch circuit 71 operates in response to the trailing edge of the output of comparator 70, and provides the output from comparator 69 as a latch output. This latch output closes switches 72 and 73.

After the transmission period for switching on the rotation angle detecting coil 42, CPU 9 switches to partial scanning for detecting the rotation angle after the lapse of a prescribed receiving period (for example, R=100 μs) at S18.

The CPU 9 causes selection circuit 2 to select the loop coil stored at S12, and connects transmission/receiving switching circuit 3 to the transmitting-side terminal T. In this state, this loop coil sends out the transmitted radio waves to indicator 1. Resonance circuit 21, including the coordinate detecting coil 41, is excited by these transmitted waves, and an induced voltage is generated in resonance circuit 61.

When switches 72 and 73 are closed, the rotation angle detecting coil 42 is switched on. Due to the magnetic flux inside coordinate detecting coil 41, it is difficult for an AC magnetic field to pass through the position of rotation angle detecting coil 42. Eddy currents tend to flow through rotation angle detecting coil 42, and the magnetic field is biased toward a position further away from rotation angle detecting coil 42 inside coordinate detecting coil 41. Therefore, the position where the radio waves are output to position detector 20 moves toward a position farther from rotation angle detecting coil 42, along a straight line connecting the center coordinates of coordinate detecting coil 41 and the central point of the ferrite core of rotation angle detecting coil 42. As a result, the coordinates detected on position detector 20 move, and another coordinate representing the rotation around the center axis of coordinate detecting coil 41 is detected.

After the transmission mode period, CPU 9 causes selection circuit 2 to select the loop coil stored at S12, and switches over transmission/receiving switching circuit 3 to the receiving-side terminal R. In this receiving mode of the loop coil, a received signal is obtained in position detector 20 by the same operations as described above at S10. At S18, partial scanning in the X-axis direction is followed by partial scanning in the Y-axis direction in the same manner as in S16.

CPU 9 stores the number of the loop coil for which the highest received signal level is detected in partial scanning for the rotation coordinate at S19.

Then, CPU 9 calculates the X, Y coordinates and the rotation angle around the Z-axis at S20. Specifically, CPU 9 acquires the highest received voltage of the loop coil for which the highest received signal level is detected in partial scanning, and the received voltage values of the preceding and following loop coils. CPU 9 determines the center coordinate values (X₀, Y₀) of coordinate detecting coil 41, and the rotation coordinate position (X₁, Y₁) after rotation by third operational input means 13. CPU 9 determines the rotation angle by the following formula on the basis of this central coordinate value and the rotation coordinate position:

θ=−180°+tan⁻¹[(X₁−X₀)/(Y₁−Y₀)]

The rotation angle is an absolute rotation angle obtained by setting an X-Y coordinate system in parallel with the X-axis and the Y-axis on position detector 20 with the detected center coordinates as an origin. A range of θ of −180°<θ≦+180° is adopted, with the positive direction of the Y-axis as a reference (θ=0).

It is possible to detect one degree of freedom information in response to the rotating operation of rotary operating member 17, serving as a third operational input means 13, as well as two degrees of freedom information in position detecting device 20 in response to movement of coordinate detecting coil 41 serving as bottom surface input means 14 on the surface of position detector 20.

In the above described embodiment of indicator 1, first operational input means 11 can enter two degrees of freedom information by operating an operating member projecting from the front portion of the upper surface of enclosure 10. Second operational input means 12 can enter one-degree of freedom information by operating sliding switch 31 exposed on the side of enclosure 10. Third operational input means 13 can enter absolute rotation angle information (one degree of freedom information) around an axis forming a right angle with the surface of position detector 20 (Z-axis) by operating rotary operating member 17 exposed on the side of enclosure 10. Bottom surface input means 14 can enter information of the XY coordinates (two degrees of freedom information) by operating within a plane in parallel with the surface of position detector 20.

Moving and rotating an object in a virtual 3D space displayed on a screen of computer 30 using indicator 1, having the configuration described above, will now be explained.

Displacement of operating member 21 of first operational input means 11 corresponds to displacement of stick controller 22, which may be tilted about 30° in all directions relative to its initial position. After operation, stick controller 22 automatically returns to the initial position. Stick controller 22 has two rotary variable resistance elements crossing each other at right angles. The resistance of the two rotary variable resistance elements continuously varies in response to the inclination direction and the inclination angle of operating member 21. Two pieces of degree of freedom information corresponding to operations represented by these continuous values are binarized by transmitting circuit 26, and transmitted to computer 30 via position detector 20.

The inclination direction of operating member 21 may conform to the rotating direction that is a synthesized component of PITCH and ROLL of the object in a virtual 3D space. It can therefore be easily interpreted by software associated with computer 30 as two degrees of freedom information for controlling the rotating direction. In this configuration, operating member 21 can be tilted to 30°. Control is therefore based on relative rotation angle control using the automatic returning mechanism. For improved operability, it is desirable to use the inclination angle of operating member 21 as a rotation speed of the object.

Lever 32 of sliding switch 31, serving as second operational input means 12, can slide about 25° from an initial position, and having a perpendicular alignment to the surface of position detector 20. After operation, it automatically returns to the initial position.

Sliding switch 31 outputs four kinds of switch codes, which vary with the sliding direction and the sliding angle of lever 32. This code information is transmitted to computer 30 by transmitting circuit 23 via position detector 20.

Vertical movement of lever 32 may be associated with the movement of the Z coordinates of the object in the virtual 3D space. It can therefore be directly processed as one-degree of freedom information for controlling the movement of the Z coordinates by software in computer 30. In this configuration, control is based on relative coordinate control using two kinds of code information on one side and the automatic returning mechanism. For improving operability, it is desirable to use these different codes as a change in the moving speed of the object (the amount of coordinate movement per scanning operation of position detector 20).

Movement of rotary operating member 17 serves as third operational input means 13, and rotates parallel to the surface of position detector 20, thereby causing rotation angle detecting coil 42 to rotate around the center coordinates of coordinate detecting coil 41 via rotation transmitting means 19. An absolute rotation angle within a range of 0 to 359° is transmitted to computer 30 by control circuit 51 and coordinate detector 20 in response to rotation angle detecting coil 42.

The rotation angle of rotary operating member 17 may be associated with the Yaw of the object in the virtual 3D space. It is therefore possible to easily process same directly as one degree of freedom information for controlling the Z-axis rotation angle by software associated with computer 30.

Finally, the center coordinates of coordinate detecting coil 41, serving as bottom surface input means 14, are detected by position detector 20 as X, Y coordinates in response to an operation on the surface of position detector 20 by indicator 1. Two degrees of freedom information of the X-Y coordinate displacement of the object in the virtual 3D space therefore uses the X, Y coordinates on the surface of the position detector.

With the configuration described above, it is possible to achieve a six degrees of freedom information input unit having a plurality of operational input means and a bottom surface input means corresponding to the displacement and rotation of the object in a 3D space. Using the indicator 1, it is possible to change the enclosure shape, the form of the plurality of operational input means, and arrangement thereof in various manners.

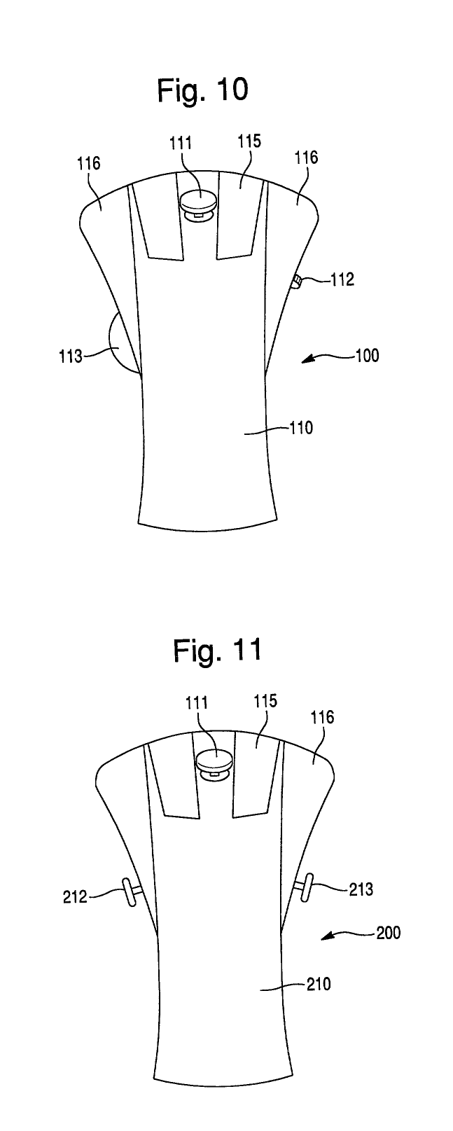

An exterior view of a second embodiment of a six degrees of freedom information indicator 100 is best shown in FIG. 10. Indicator 100 includes an operating member 111 of a stick controller projecting from the front portion of the upper surface of an enclosure 110. Operating member 111 may enter two degrees of freedom information for controlling the rotating directions around the X-axis and the Y-axis, respectively. A lever 112 of a sliding switch is exposed from a side surface of enclosure 110, which may enter one degree of freedom information for controlling the displacement of the Z-coordinate. A rotary operating member 113 is exposed from opposing side of enclosure 110 (relative to lever 112), and may enter one degree of freedom information for controlling the absolute rotation angle around the Z-axis.

Indicator 100 also includes an operating switch 115, as on a mouse, and a pair of finger rests 116 having felt or the like on the surface to prevent user slippage of indicator 100 during operation. Finger rests 116 are arranged symmetrically, on opposing sides of the upper surface of enclosure 110, as shown in FIG. 10. Finger rests 116 are also effective in supporting the user's fingers that are not engaged in operation, thus improving the ease of use.

An exterior view of a third embodiment of a six degrees of freedom information indicator 200 is best shown in FIG. 11. Components that correspond to identical components from the second embodiment are numbered accordingly. An operating member 212 is exposed on a side of an enclosure 210 of indicator 200, and is an operating member of a stick controller similar to that used in the first embodiment described above. Operating member 212 has an initial position that is perpendicular to the surface of position detector 20, and may be used to enter one degree of freedom information for controlling the Z-axis displacement. Operating member 212 may be moved parallel to the surface of position detector 20 (i.e. forward-backward), and enters one degree of freedom information for controlling the rotation angle around the Z-axis. Transmitting circuit 26 therefore differs from the first embodiment in that continuous changes in the resistance values of the two rotary variable resistance elements of this stick controller are input to converting means 83-3 and 83-4.

A second operating member 213 is also provided, which is symmetrically positioned relative to operating member 212, as shown in FIG. 11. Operating member 213 is similarly configured, and provides the same functions, as operating member 212. As such, it is possible to enter two degrees of freedom information by operating either operating member 212 or operating member 213, depending on user preference. Such a configuration is particularly effective when using indicator 200 with one hand in a multi-mode of position detector 20 (i.e. a mode in which a plurality of position indicators are used).

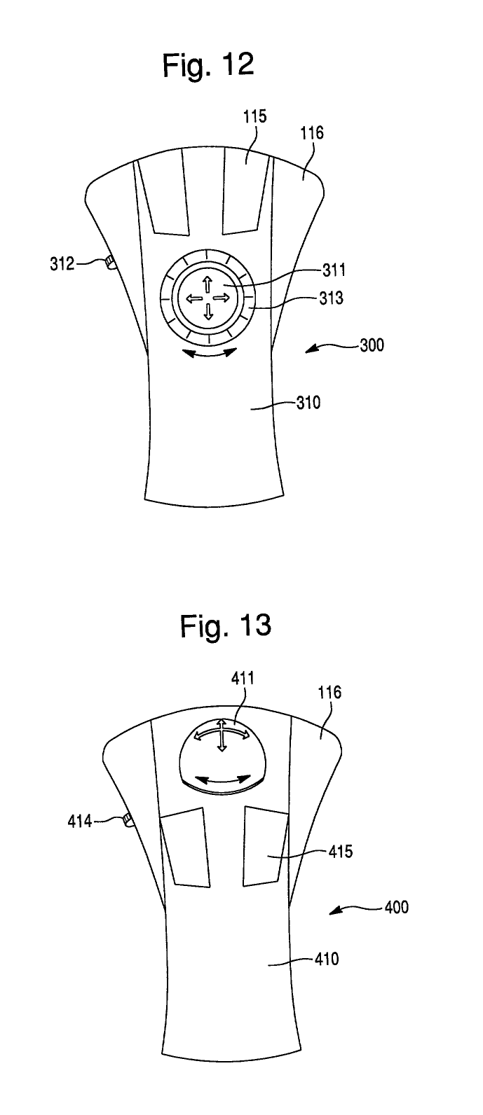

An exterior view of a fourth embodiment of a six-degree of freedom information indicator 300 is best shown in FIG. 12. Again, components corresponding to components from the second embodiment are numbered accordingly. Indicator 300 has a multi-functional operational input means capable of entering three degrees of freedom information toward the center of the front upper surface of enclosure 310. A typical multi-functional input means is a RKJXM-switch-type multi-functional operating device made by Alps Electric Co., Ltd. Such an input device provides an eight-direction detector switch and a dual-phase encoder. Indicator 300 is configured so that two degrees of freedom information for controlling rotation around the X-axis and Y-axis, respectively, are entered by operating an inner-axis stick switch 311. One degree of freedom information for controlling the Z-axis displacement is entered by rotating an outer-axis encoder section 313. One degree of freedom information for controlling the Z-axis displacement is entered by means of a lever 312 of the sliding switch exposed at a side of enclosure 310.

An exterior view of a six degrees of freedom information indicator 400 according to a fifth embodiment is best shown in FIG. 13. Components corresponding to those explained in the second embodiment are numbered accordingly. Two degree of freedom information for controlling the rotation around the X-axis and the Y-axis, respectively, and one degree of freedom information for controlling the rotation around the Z-axis, are entered by rotating a trackball 411 in one of three directions, as indicated by arrows A, B and C in FIG. 13. Trackball 411 is positioned on the front upper surface of an enclosure 410 of indicator 400. One degree of freedom information for controlling the Z-coordinate displacement is entered by rotating a rotary operating member 414 of a rotary encoder provided on a side of enclosure 410. Operating member 414 may be rotated within a plane that is perpendicular to the surface of position detector 20. The spherical surface of trackball 411 is in contact with a rotary member (not shown), which is connected to rotation shafts for three rotary encoders. The rotary encoders output a code signal in response to the rotating direction, and the amount of rotation, of trackball 411. The encoder associated with rotary operating member 414 also outputs a code signal in response to the rotating direction, and the amount of rotation, of rotary operating member 414. These output signals are transmitted to the computer 30 via position detector 20 by entering them into control means 85 of transmitting circuit 26.

In the fifth embodiment of the invention, operating member 414 may be an inertial wheel having a large inertial moment. Such an inertial wheel, once rotated, tends to continue rotational motion under the effect of inertia even after the user removes his or her fingers. It is therefore possible to generate a large amount of rotation by a single operation, thereby causes high-speed rotation of the inertial wheel. In this way, it is possible to provide an input operational environment suitable for controlling a high-speed displacement or a large displacement in the Z-axis direction. In this case, a non-contact encoder such as an optical rotary encoder is preferable. However, any other type of encoder known in the art may also be used.

The six degrees of freedom information indicator according to the present invention permits input of six degrees of freedom information, corresponding to displacement and rotation of an object in 3D space on a computer display. However, it is also possible to prevent input for a particular degree of freedom information that the user does not wish to enter by means of software. In this way, the indicator according to the present invention may also be used as a conventional GUI navigation indicator.

A simultaneous control mode and an independent control mode may be selected using various operational input means in response to various computer applications, or by using software-processing input information from the operational input means in a driver for the position detector. The present invention provides an input operating environment in which control of six degrees of freedom information may be achieved by manipulating the spatial object displayed. The present invention is applicable to a wide range of application environments, such as computer graphics and 3D CAD, which require input in a plurality of degrees of freedom. The present invention further provides an input operating environment in which the operator can independently enter a plurality of degrees of freedom with one hand, while operating a plurality of operational input means. Thus, the thumb and forefinger are relatively free.

It will be apparent to one of ordinary skill in the art that various modifications and variations can be made in construction or configuration of the present invention, without departing from the scope or spirit of the invention. It is intended that the present invention cover all modifications and variations of the invention, provided they come within the scope of the following claims and their equivalents.

What is claimed is:

1. A six degrees of freedom information indicator used in combination with a position detector, using electromagnetic induction, which enables an operator to enter six degrees of freedom information into a computer by operating the indicator while holding the indicator one-handed, comprising:
an enclosure having a bottom surface;
a plurality of operational input means provided at a portion touched by an operator's fingers on said enclosure of a six degrees of freedom information indicator and operable by the operator's fingers independently of each other;
a bottom surface input means comprising a coordinate detecting coil provided on said bottom surface; and
transmitting means for transmitting to a position detector one or more degrees of freedom information signals, each of the signals corresponding to the operator operating at least one of said plurality of input means, by using electromagnetic induction, wherein:
four degrees of freedom information are entered by the operator operating said plurality of operational input means, and two degrees of freedom information in each of an X and a Y directions are entered by entering and moving said enclosure within a plane of parallel to said bottom surface of said position detector.

2. A six-degree of freedom information indicator according to claim 1, wherein said transmitting means comprises:
receiving means which receive an AC electric field, an AC magnetic field, or an AC electromagnetic field of a certain frequency irradiated from said position detector;
returning means which return an AC electric field, an AC magnetic field, or an AC electromagnetic field of the certain frequency to said position detector;
converting means which convert one or more pieces of degree-of-freedom information corresponding to the operation of at least one operational input means from among said plurality of operational input means, into time periods;
counting means which perform binarization by counting the number of waves of the AC electric field, the AC magnetic field, or the AC electromagnetic field of the certain frequency received during one or more time periods converted by said converting means; and
control means which control said receiving means in response to binary codes representing a plurality of pieces of degree-of-freedom information determined by said counting means, and said control means causing a change in the AC electric field, the AC magnetic field, or the AC electromagnetic field output to said position detector.

3. A six degrees of freedom information indicator according to claim 2, wherein:
said receiving means and said returning means are resonance circuits comprising said coordinate detecting coil.

4. A six degrees of freedom information indicator according to claim 1, wherein:
at least one of said plurality of operational input means has a time constant circuit and acquires a continuous amount of operation by the operator as continuous analog information.

5. A six degrees of freedom information indicator according to claim 1, wherein:
at least one of said plurality of operational input means has a switch detecting circuit and acquires discrete amount of operation by the operator as discrete digital information.

6. A six degrees of freedom information indicator according to claim 3, wherein one of said plurality of operational input means comprises:
a rotary member which performs rotating movement around a center of said coordinate detecting coil;
an operating member which causes said rotary member to rotate when operated by the operator;
a rotation angle detecting coil having a center that is shifted toward the inside of said coordinate detecting coil so that the position varies along with rotation of said rotary member, and having a radius smaller than that of said coordinate detecting coil; and
a control circuit for controlling an open and a closed state of at least said rotation angle detecting coil and for causing a change in the distribution of magnetic flux passing through the coordinate detecting coil, wherein absolute rotation angle information around the Z-axis is detected by use of electromagnetic induction when the operator rotates said operating member.

7. A six degrees of freedom information indicator according to claim 1, wherein:
each of said plurality of operational input means has an inertial wheel, and movement information in the Z-axis direction is entered through inertial rotation of said inertial wheel.

8. A six degrees of freedom information indicator according to claim 1, wherein:
each of said plurality of operational input means is a stick controller or a sliding switch which automatically returns to an initial position when the operator releases said operational input means.

9. A six degrees of freedom information indicator according to claim 1, wherein:
each of said plurality of operational input means is an absolute information input means which maintains the information upon completion of operation when the operator releases said operational input means.

10. An indicating method using a six degrees of freedom information indicator in combination with a position detector using electromagnetic induction, which method enables an operator to enter six degrees of freedom information into a computer by operating the indicator while the operator holds the indicator one-handed, comprising the steps of:
detecting that the operator operates a plurality of operational input means, provided on the portion on an enclosure of said six degrees of freedom information indicator touched by the operator's fingers and independently operable by the operator's fingers;
transmitting to said position detector one or more signals corresponding to the operation detected in said operational input detecting step, by use of electromagnetic induction;
entering into a computer information processed in said signal transmitting step, except for X and Y information, as four degrees of freedom information; and
entering by means of bottom surface input means provided on the bottom surface of said six-degree of freedom information indicator, two degrees of freedom information as a result of detecting that the operator moves said six degrees of freedom information indicator as two degrees of freedom information, into the computer.

11. An indicating method using a six degrees of freedom information indicator in combination with a position detector using electromagnetic induction, which method enables an operator to enter six degrees of freedom information into a computer by operating the indicator while the operator holds the indicator one-handed, comprising the steps of:
detecting that the operator operates a plurality of operational input means, provided on the portion on an enclosure of said six degrees of freedom information indicator touched by the operator's fingers and independently operable by the operator's fingers;
transmitting to said position detector one or more signals corresponding to the operation detected in said operational input detecting step, by use of electromagnetic induction;
entering the information processed in said signal transmitting step into a computer as three degrees of freedom information, except for X and Y information and rotation information around the Z-axis;
detecting as a rotation coordinate around the Z-axis, the rotation and a rotation angle detecting coil as a result of the operation by the operator causing the rotation of a rotary member of one of said plurality of operational input means relative to a coordinate detecting coil forming a bottom surface input means provided on the bottom surface of said six degrees of freedom information indicator, and entering the detected rotation coordinate as one degree of freedom information into the computer; and
entering by means of bottom surface input means provided on the bottom surface of said six-degree of freedom information indicator, two degrees of freedom information as a result of detecting that the operator moves said six degrees of freedom information indicator as two degrees of freedom information, into the computer.

12. A system for entering six degrees of freedom information for controlling movement and rotation of an object displayed on a display operably associated with a computer, comprising:
an electromagnetic induction position detector, said position detector operably associated with the computer;
an indicator operably associated with said position detector;
a resonance circuit carried by said indicator, said resonance circuit for operable association with said position detector for determining X-axis and Y-axis coordinate values and a rotation angle around a Z-axis;
a plurality of input members positioned on said indicator for generating signals for one or more degrees of freedom information values, the signals generated in response to operation of one of said plurality of input members by a user; and
a transmitting circuit for transmitting the signals output from said plurality of input members to said position detector.

13. The system of claim 12, wherein said indicator comprises an enclosure having an upper surface, a bottom surface, a first side surface and a second side surface.

14. The system of claim 13, wherein said resonance circuit comprises a capacitor and a coordinate detecting coil.

15. The system of claim 14, wherein said position detector comprises a plurality of loop coils.

16. The system of claim 15, wherein said plurality of loop coils and said coordinate detecting coil communicate using electromagnetic induction for determining the X-axis and Y-axis coordinate values, which correspond to a position of said indicator on a detecting surface of said position detector.

17. The system of claim 16, wherein said coordinate detecting coil communicates six degrees of freedom information to said position detector in response to an operation of one of said plurality of input members.

18. The system of claim 14, wherein said plurality of input members comprises:
a first input member for transmitting at least two degrees of freedom information values;
a second input member for transmitting one degree of freedom information value; and
a third input member for transmitting one degree of freedom information value.

19. The system of claim 15, wherein said first input member comprises an operating member operably associated with a stick controller.

20. The system of claim 19, wherein said operating member is positioned on said upper surface at one end of said enclosure.

21. The system of claim 20, wherein said operating member has an initial position perpendicular to said upper surface, and said operating member is tiltable about 30 degrees relative to said initial position.

22. The system of claim 15, wherein said second input member comprises a sliding switch and a lever thereon.

23. The system of claim 12, wherein said indicator further comprises two switches for operating graphical user interface navigation applications associated with the computer.

24. The system of claim 12, wherein said position detector is selected from the group consisting of a digitizer and a tablet.

25. A method of entering information for six degrees of freedom of an object displayed on a display operably associated with a computer, comprising the steps of:
detecting an operation of at least one of a plurality of input members positioned on an enclosure;
transmitting at least one degree of freedom information signal corresponding to the operation of at least one of the plurality of input members to a position detector;
processing transmitted signals by the computer into values corresponding to six degrees of freedom information; and
displaying an object on a display having a position corresponding to the processed values.

26. The method of claim 25, comprising the further steps of:
detecting a position of the enclosure on a surface of the position detector;
